(19) United States
(12) Patent Application Publication
(10) Pub. No.: US 2026/0181440 A1
(43) Pub. Date: Jun. 25, 2026

(54) EARLY PREDICTED MEASUREMENTS AND REPORTING

(71) Applicant: InterDigital Patent Holdings, Inc., Wilmington, DE (US)

(72) Inventors: Brian Martin, Farnham (GB); Oumer Teyeb, Montreal (CA); Dylan Watts, Montreal (CA); Patrick Tooher, Montreal (CA)

(73) Assignee: InterDigital Patent Holdings, Inc., Wilmington, DE (US)

(21) Appl. No.: 18/989,036

(22) Filed: Dec. 20, 2024

(51) Int. Cl. H04W 24/10; H04W 52/02

(52) U.S. Cl. CPC H04W 24/10; H04W 52/0209

(57) ABSTRACT

A wireless transmit/receive unit (WTRU) may be configured to perform measurements and measurement predictions in an idle state or an inactive state (e.g., low-power operation mode). The WTRU may perform measurements for the configured idle measurement durations. If the WTRU stays in the idle state or the inactive state for more than a validity duration after it has stopped performing measurements, the WTRU may perform measurement predictions. Upon transitioning to a CONNECTED state (full-power operation mode), the WTRU may report the actual measurements, if they are still valid, or otherwise, report the predicted measurements.

### BACKGROUND

A network may configure a wireless transmit/receive unit (WTRU), also referred to as a user equipment (UE), with Carrier Aggregation (CA) or/and Dual Connectivity (DC) in order to increase the data rate per user. In some cases, this also may increase reliability. In CA, the WTRU simultaneously sends/receives data to/from multiple cells of a given network node, such as a next generation node B (gNB), that are operating at different carrier frequencies. In DC, on the other hand, the WTRU is connected to two serving network nodes (e.g., gNBs), known as the master node (MN) and the secondary node (SN). When operating in DC, the WTRU further may be configured in CA within the MN and/or SN. The set of cells under the MN that are configured for the UE are known as the Master Cell Group (MCG), and the set of cells under the SN are referred to as the Secondary Cell Group (SCG). The primary cell in the MCG is referred to as PCell, and the primary cell in the SCG is known as PSCell. The term SPCell (special Cell) is used to refer to either the PCell or the PSCell. The cells other than the SPCells are known as SCell (Secondary Cells). The network normally decides to set up CA and/or DC for a WTRU based on measurement reports received from the WTRU. However, when it is time for the WTRU to connect to the network, the measurement reports may not be valid.

### SUMMARY

As described herein, a WTRU may be configured to perform measurements and measurement predictions while in a low-power operation mode, such as, for example, an idle or inactive state (IDLE/INACTIVE). Measurements and/or predictions may be performed regarding reference signal received power (RSRP), reference signal receive quality (RSRQ), received signal strength indicator (RSSI), signal to interference noise ratio (SINR), channel quality indicator (CQI), channel state information (CSI), or the like. The WTRU may be configured to perform measurements for configured idle measurement durations, and if the WTRU stays more than an idle measurement validity duration after it has stopped the measurements, the WTRU may be configured to perform measurement predictions. Upon transitioning to a full-power operation mode, such as, for example, a connected state (CONNECTED), the WTRU may be configured to report the actual measurements (e.g., if they still are valid) or the predicted measurements, otherwise.

An example WTRU may comprise a transceiver and a processor. The processor may be configured to send, via the transceiver, an indication of a measurement prediction capability. The processor may be configured to receive, via the transceiver, a message. The message may comprise instructions for the WTRU to enter a low-power operation mode, such as, for example, an idle state or an inactive state (e.g., idle/inactive state). The message may comprise configuration information associated with measurements to be performed while the WTRU is the in idle/inactive state. The message may comprise configuration information associated with measurements to be predicted while the WTRU is in the inactive/idle state. The processor may be configured to enter the inactive/idle state. The processor may be configured to, while in the idle/inactive state, perform measurements based on the received configuration information. The processor may be configured to, while in the idle/inactive state, based on a trigger condition, predict measurements based on the received configuration information and the performed measurements. The processor may be configured to transition to a full-power operation mode, such as, for example, a connected state. The processor may be configured to send, via the transceiver, at least one of an indication of the performed measurements or an indication of the predicted measurements.

The measurement prediction capability may comprise at least one of a frequency associated with the measurement prediction, a cell associated with the measure prediction, a time associated with the measurement prediction, a location associated with the measurement prediction, or a confidence level associated with the measurement prediction. The measurement prediction capability may be sent in a radio resource management (RRM) message. The message may comprise a radio resource control release (RRCRelease) message.

The configuration information may comprise at least one of a carrier associated with measurement performance, a frequency associated with measurement performance, a measurement duration, a measurement validity duration, or a validity area. The configuration information comprises at least one of a carrier associated with measurement prediction, a frequency associated with measurement prediction, a prediction duration, a prediction validity duration, or a prediction model.

The trigger condition may comprise an expiration of a validity duration. The trigger condition may comprise a location of the WTRU being within a threshold distance from a reference location. The trigger condition may comprise an absolute time measured at the WTRU being within a time window. The transition to the connected state may be based upon at least one of receipt of a paging message comprising an indication of downlink (DL) data, detection of uplink (UL) data, receipt of a radio resource control (RRC) setup request message, or receipt of an RRC resume request message.

An example method performed by a WTRU, may comprise sending an indication of a measurement prediction capability. The method may comprise receiving a message. The message may comprise instructions for the WTRU to enter a low-power operation mode, such as, for example, an idle state or an inactive state (e.g., idle/inactive state). The message may comprise configuration information associated with measurements to be performed while the WTRU is in idle/inactive state. The message may comprise configuration information associated with measurements to be predicted while the WTRU is in the inactive/idle state. The method may comprise entering the inactive/idle state. The method may comprise, while in the idle/inactive state, performing measurements based on the received configuration information. The method may comprise, while in the idle/inactive state, based on a trigger condition, predicting measurements based on the received configuration information and the performed measurements. The method may comprise transitioning to a full-power operation mode, such as, for example, a connected state. The method may comprise sending at least one of an indication of the performed measurements or an indication of the predicted measurements.

The measurement prediction capability may comprise at least one of a frequency associated with the measurement prediction, a cell associated with the measure prediction, a time associated with the measurement prediction, a location associated with the measurement prediction, or a confidence level associated with the measurement prediction. The measurement prediction capability may be sent in a radio resource management (RRM) message. The message may comprise a radio resource control release (RRCRelease) message.

The configuration information may comprise at least one of a carrier associated with measurement performance, a frequency associated with measurement performance, a measurement duration, a measurement validity duration, or a validity area. The configuration information may comprise at least one of a carrier associated with measurement prediction, a frequency associated with measurement prediction, a prediction duration, a prediction validity duration, or a prediction model.

The trigger condition may comprise an expiration of a validity duration. The trigger condition may comprise a location of the WTRU being within a threshold distance from a reference location. The trigger condition may comprise an absolute time measured at the WTRU being within a time window. The transition to the connected state may be based upon at least one of receipt of a paging message comprising an indication of downlink (DL) data, detection of uplink (UL) data, receipt of a radio resource control (RRC) setup request message, or receipt of an RRC resume request message.

An example computer-readable storage medium may have executable instructions stored thereon for configuring at least one processor to send an indication of a measurement prediction capability. The executable instructions may configure the processor to receive a message. The message may comprise instructions for the WTRU to enter a low-power operation mode, such as, for example, an idle state or an inactive state (e.g., idle/inactive state). The message may comprise configuration information associated with measurements to be performed while the WTRU is in idle/inactive state. The message may comprise configuration information associated with measurements to be predicted while the WTRU is in the inactive/idle state. The executable instructions may configure the processor to enter the inactive/idle state. The executable instructions may configure the processor to, while in the idle/inactive state, perform measurements based on the received configuration information. The executable instructions may configure the processor to, while in the idle/inactive state, based on a trigger condition, predict measurements based on the received configuration information and the performed measurements. The executable instructions may configure the processor to transition to a full-power operation mode, such as, for example, a connected state. The executable instructions may configure the processor to send at least one of an indication of the performed measurements or an indication of the predicted measurements.

The measurement prediction capability may comprise at least one of a frequency associated with the measurement prediction, a cell associated with the measure prediction, a time associated with the measurement prediction, a location associated with the measurement prediction, or a confidence level associated with the measurement prediction. The measurement prediction capability may be sent in a radio resource management (RRM) message. The message may comprise a radio resource control release (RRCRelease) message.

The configuration information may comprise at least one of a carrier associated with measurement performance, a frequency associated with measurement performance, a measurement duration, a measurement validity duration, or a validity area. The configuration information may comprise at least one of a carrier associated with measurement prediction, a frequency associated with measurement prediction, a prediction duration, a prediction validity duration, or a prediction model.

The trigger condition may comprise an expiration of a validity duration. The trigger condition may comprise a location of the WTRU being within a threshold distance from a reference location. The trigger condition may comprise an absolute time measured at the WTRU being within a time window. The transition to the connected state may be based upon at least one of receipt of a paging message comprising an indication of downlink (DL) data, detection of uplink (UL) data, receipt of a radio resource control (RRC) setup request message, or receipt of an RRC resume request message.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures and the detailed description are not to be considered limiting, and other equally effective examples are possible and likely. Like reference numerals (“ref.” or “refs.”) in the Figures indicate like elements.

FIG. 1A is an example system diagram illustrating an example communications system in which one or more disclosed embodiments may be implemented.

FIG. 1B is an example system diagram illustrating an example wireless transmit/receive unit (WTRU) that may be used within the communications system illustrated in FIG. 1A according to an embodiment.

FIG. 1C is an example system diagram illustrating an example radio access network (RAN) and an example core network (CN) that may be used within the communications system illustrated in FIG. 1A according to an embodiment.

FIG. 1D is an example system diagram illustrating a further example RAN and a further example CN that may be used within the communications system illustrated in FIG. 1A according to an embodiment.

FIG. 2 depicts an example flow chart for utilizing early measurements to quickly setup carrier aggregation (CA) and/or dual connectivity (DC) when a WTRU transitions to a connected state, also referred to herein as a full-power operation mode, (radio resource control (RRC)_CONNECTED) from an inactive state (RRC_INACTIVE).

FIG. 3 depicts an example flow chart for performing measurements and measurement prediction.

### EXAMPLE NETWORKS FOR IMPLEMENTATION OF THE INVENTION

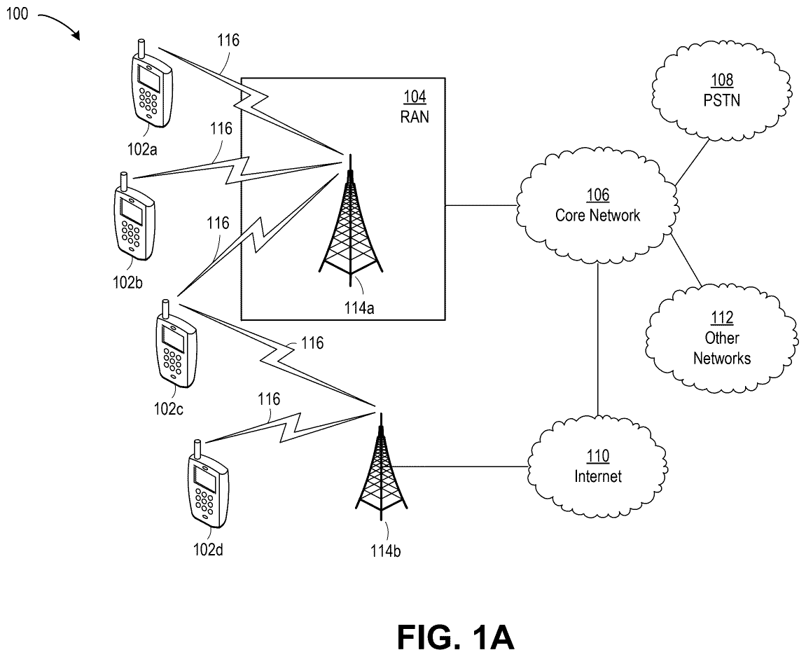

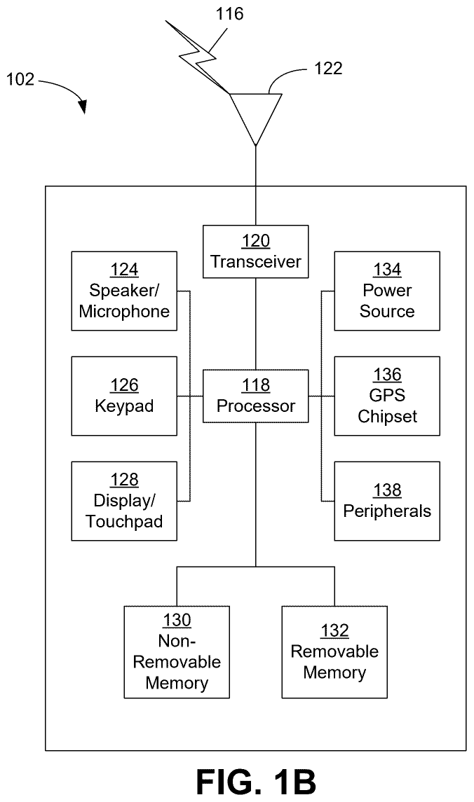

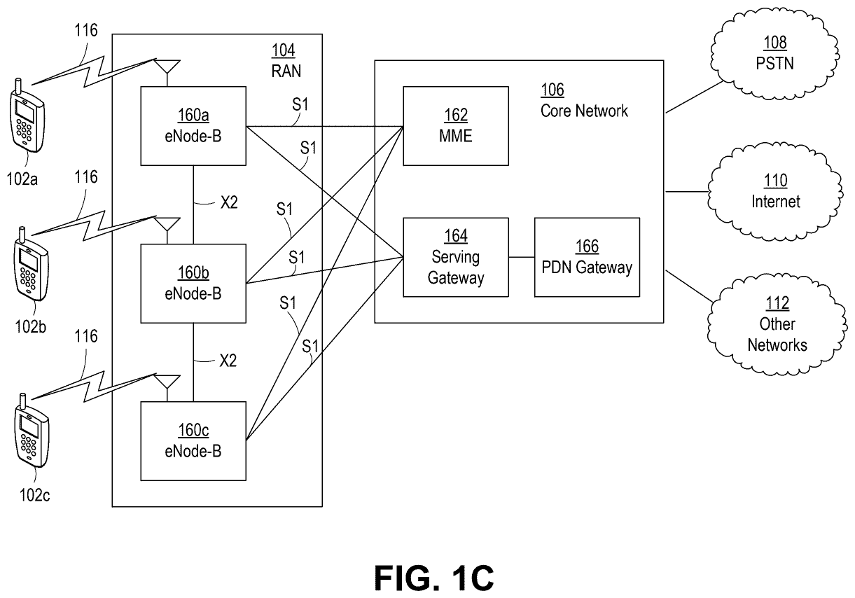

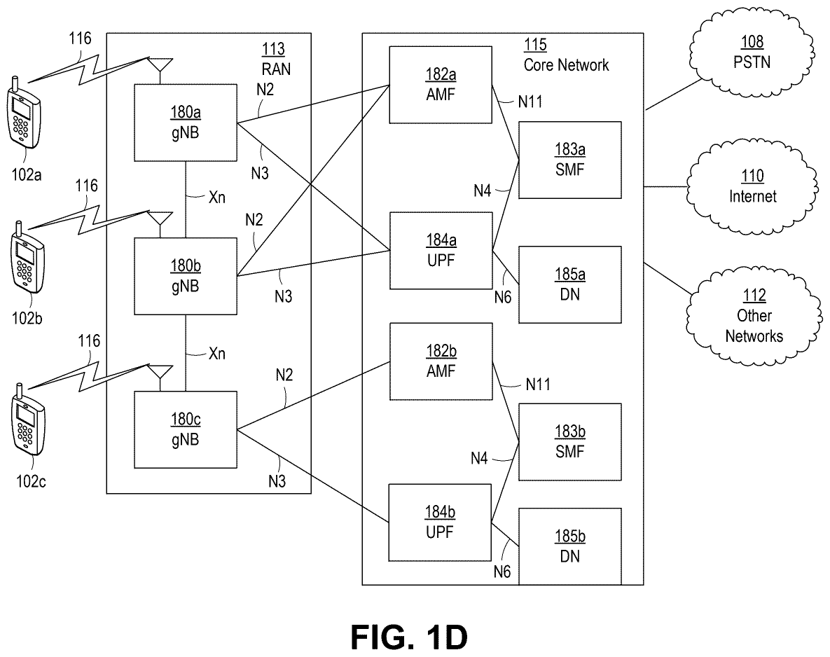

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attachment of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example, in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP (third generation partnership project) access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A WTRU may be configured to perform measurements and measurement predictions in the idle state and/or the inactive state (IDLE/INACTIVE), which are examples of a low-power operation mode. A network may decide to setup CA and/or DC for a WTRU based on measurement reports received from the WTRU regarding neighbouring cells (though there is nothing preventing the network from configuring CA or/and DC blindly). In order to enable a quick setup of CA and/or DC as soon as the WTRU transitions into a connected state (full-power operation mode), referred to as radio resource control_connected (RRC_CONNECTED), early measurement reporting (also known as IDLE/INACTIVE measurements) may be performed. The WTRU may be configured to perform measurements on neighboring cells (intra-frequency, inter-frequency, or/and inter-RAT neighbor cells) while it is in an inactive state (RRC_INACTIVE) or an idle state (RRC_IDLE). When the WTRU transitions to the RRC_CONNECTED state, the WTRU can send the measurements, letting the network know if there are candidate neighbor cells that can be configured in CA or DC mode for the WTRU.

Throughout this disclosure, the terms artificial intelligence (AI)/machine language (ML) and AIML are used interchangeably. The terms “data”, “measurements”, “report” and “results” are used interchangeably. The terms starting conditions and validity conditions are used interchangeably. The terms indication, information, and message are used interchangeably. The terms “current cell”, “serving cell” and “source cell” are used interchangeably. The terms “neighbor cell”, “target cell” and “candidate cell” are used interchangeably.

Although of the descriptions provided here are on measurement prediction based on AIML models, the proposed mechanisms are equally applicable to any other form of prediction that does not use AIML (e.g. time series forecasting, interpolation methods, etc.).

All descriptions herein are agnostic to the kind of AIML model/technique used by the WTRU (e.g., the algorithm used, the mechanism such as neural network or what kind of neural network, e.g., depth and parameters/weights of the network, etc.), the origins of the model (e.g., WTRU vendor, operator, network vendor, etc.), or how/where the training of the model is done (e.g., the input data used for the training, where the training is performed, if the training is performed offline or online, etc.). However, it may be assumed that the model is trained based on historical observation of one or more WTRU's actual measurements in different WTRU and network conditions (e.g., during certain time durations of the day, during certain days of the week, at different locations, different WTRU mobility patterns/speeds, under different network conditions that are visible to the WTRU such as frequency/bandwidth, etc., under different network configurations, which may be visible to the WTRU just as a network configuration index that is provided by the network at the time of training or data collection for the training, etc.).

Furthermore, there may be some WTRU capability communication between the WTRU and the network about AIML capability (e.g., where the WTRU can indicate to the network the supported AIML models/functions, confidence level of predictions, time horizon of predictions (how far along in the future are the prediction being made), etc.).

The WTRU may support several AIML models for a certain functionality (e.g., with different prediction time horizons, prediction confidence levels, processing requirements, trained under/for operation in different frequencies/cells/location/times of day, etc.).

A given AIML model may operate in different modes (e.g., with different levels of prediction confidence levels at different prediction time horizons, at different locations, frequencies, UE mobility pattern/speed, etc.).

A WTRU may choose the AIML model to use for a certain functionality (e.g., network decides for which functionalities the WTRU can use AIML based operation, and the WTRU chooses the AIML model to use) or the network may explicitly control this (e.g., WTRU provides details of AIML models and their capabilities, network determines which model to activate for a particular functionality).

The AIML models may be available at the WTRU already trained, or the WTRU may be provided with an untrained AIML model and performs the training by itself.

The AIML model may be available at the WTRU already trained, and the WTRU may be enabled/configured to perform further training (e.g., for different conditions such as frequencies/cells/location/times of day, for the same conditions as the initial training but for increasing the level of confidence or/and the prediction time horizon, for different UE speeds, etc.).

The AIML model may be available at the WTRU but not trained at all or only trained for certain WTRU/network conditions, and WTRU may be configured to train the model (e.g. for the conditions that it is not trained for).

A WTRU may receive some configurations/inputs for performing the inference using an AIML model. For example, for beam prediction, a WTRU may be configured with a certain number of beams to measure other beams (this is referred to as set A/B configuration). In some cases, the WTRU may communicate the configuration/input as part of the capability information. In other cases, the configuration/input may be communicated to the network after capability request (e.g., based on explicit network request, if the WTRU gets configured to do AIML based operations and it has determined that it is lacking the required configuration/input, etc.).

A given AIML functionality may be associated with a set of KPI (Key Performance Indicators) or metrics. For example, this could be prediction accuracy, average or mean square difference between measured and predicted values etc. (e.g., for the beam prediction, these could be the beam prediction accuracy or/and confidence level, Layer 1 (L1) Reference Signal Received Power (RSRP) difference between the measured and predicted beam signal levels, etc.). A WTRU may have one or more AIML models for a given functionality, and each model may have performance levels that meet different KPI thresholds (e.g., WTRU may have 2 models, where one has an accuracy level of 90% and another one with an accuracy level of 95%, etc.) and the WTRU may inform the network during its capability reporting or after the capability reporting.

A given AIML model may be trained under certain WTRU and network conditions. For example, a WTRU condition could be the speed of the WTRU. Network conditions could be something that may be related to some network configurations/settings that the WTRU may not be aware of but may impact the performance of the model. For example, an AIML beam management model may perform differently if it is trained when the network was using a certain antenna pattern, beam pattern, power levels, and so on. Also, there could be aspects related to network load, that may have impact on the model performance. Since the WTRU may not necessarily need to know all these (e.g., network may also not want to expose some of these implementation), the network could hide these details by signaling to the WTRU a network configuration index or associated ID. For example, when data is being collected for training a model, tagging may be performed indicating under which network conditions the model is being trained. When a WTRU is being configured to perform an AIML operation, it may be configured to check the consistency between the conditions under which the AIML model is trained on and current conditions (e.g., current WTRU conditions, current associated ID signaled by the network indicating current network conditions/settings, etc.).

The focus of this disclosure is not on the Life Cycle Management (LCM) of the beam/cell measurement prediction models/functionality. That is, it may be assumed that the WTRU is using a certain model for beam prediction that has been trained and performance tested for the current WTRU and network conditions. However, some of the descriptions herein can be used to enable some LCM aspects. For example, the measurement results the WTRU provides that contain actual measurements and predicted measurements, according to any of the mechanisms described below, may be collected, and used for performance monitoring or model retraining. In another example, the WTRU also may be configured to do actual measurements of some of the cells/beams in parallel with using the AIML model to predict the beams/cells (e.g., in temporal or spatial manner), compare the actual measurements and the predicted ones and decide to switch from one model to another and so on based on this comparison.

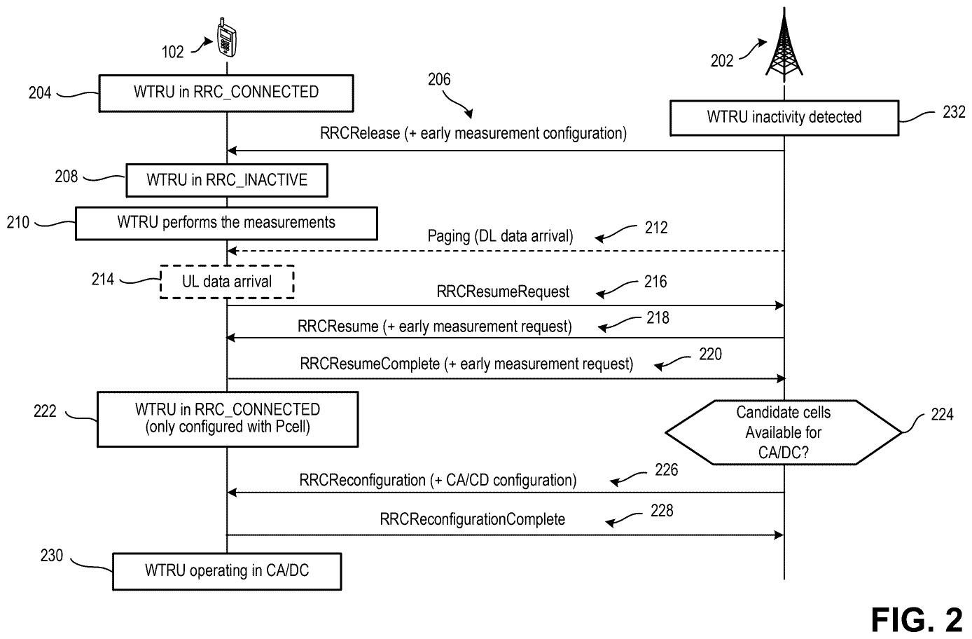

FIG. 2 depicts an example flow chart for utilizing early measurements to quickly setup carrier aggregation (CA) and/or dual connectivity (DC) when a WTRU transitions to a connected state (RRC_CONNECTED), also referred to herein as full-power operation mode, from an inactive state (RRC_INACTIVE), also referred to as low-power operation mode. As depicted in FIG. 2, a WTRU (102) may be provided, by a network (202), with an early measurement configuration (step 206) upon transitioning to an RRC_INACTIVE state (208) from an RRC_CONNECTED state (204). The network (202) may provide the configuration upon detecting WTRU inactivity (232). The WTRU (102) may perform measurements (step 210) while it is in the RRC_INACTIVE state (208). The WTRU (102) may transition to the RRC_CONNECTED mode (222), upon receiving paging due to downlink (DL) data arrival (step 212), or when arrive uplink (UL) data (214) needs to be sent, or the like. When the WTRU (102) is transitioning to RRC_CONNECTED mode (222), the WTRU (102) may trigger an RRC Resume procedure by sending an RRC Resume Request message (step 216). The network (202) may request the WTRU (102) to send the measurements performed during RRC_INACTIVE mode in an RRC Resume message (step 218), which the WTRU (102), may provide in an RRC Resume Complete message (step 220). Based on receipt of the measurement data, the network (202) may immediately, or as soon as practicable, configure CA/DC (step 226), if such candidate cells are available (step 224). Based upon receipt of the configuration data (provided at step 226), the WTRU (102) may provide a reconfiguration complete message (RRCReconfigurationComplete) to the network (202) (at step 228). Subsequently, the WTRU (102) may operate in the CA and/or DC mode (230).

Without early measurements the setup of CA/DC may be considerably delayed because the WTRU has to be configured with measurements to perform after the transition to RRC_CONNECTED, and the network has to wait until the WTRU has performed these measurements and sent the measurement report before configuring CA/DC.

The IDLE/INACTIVE (low-power operation mode) measurement configuration may be provided (step 206) to the WTRU (102) either via dedicated message (e.g., in measIdleConfig information element(IE) in the RRCRelease message when the WTRU is transitioned to IDLE/INACTIVE) or the WTRU may get it from System Information Block Type 11 (SIB 11), which may be in, for example a System Information Block 1 Enhanced Information Element (e.g., measIdleConfig-SIB IE).

The measIdleConfig IE may contain the following information. The measIdleConfig IE may contain a list of new radio (NR) carrier frequencies to be measured (e.g., for CA or DC candidate NR cells). This may contain additional information such as the list of cells to be measured, the quality to be measured, such as for example Radio Signal Received Power (RSRP) or Radio Signal Received Quality (RSRQ), RSRP/RSRQ thresholds indicating which cells are to be included in the measurement report, details of a Synchronization Signal Block (SSB) and beam configurations, etc.

The measIdleConfig IE may contain a list of Evolved Universal Terrestrial Radio Assess (EUTRA) (e.g., LTE) frequencies (e.g., for inter-RAT (radio access technology) candidate cells for DC with NR, e.g., EN-DC (Evolved Non-standalone Dual Connectivity), NE-DC (NR E-UTRA Dual Connectivity)). This may contain additional information such as the list of cells to be measured, the quality to be measured (e.g., RSRP and/or RSRQ), RSRP/RSRQ thresholds indicating which cells are to be included in the measurement report, etc.

The measIdleConfig IE may contain an indication of idle measurement duration (e.g., a value that may be, for example, from 10 seconds to 300 seconds). This may specify for how long the WTRU may keep performing the measurements while in the IDLE/INACTIVE state (low-power operation mode).

The measIdleConfig IE may contain an indication of validity area specifying a list of frequencies (and optionally cells within that frequency). The WTRU may stop the measurements if it reselects to a cell that is not included in this validity area.

The validity area is optional, and the WTRU may be configured with at least a list of NR or a list of EUTRA frequencies (e.g., it can also be configured with both).

One drawback of measurements performed in IDLE/INACTIVE is that they could be outdated (e.g., the WTRU may be transitioned to the IDLE/INACTIVE several seconds or even minutes after it has stopped the measurements in IDLE/INACTIVE, according to the configured idle measurement duration). Accordingly, a WTRU may be configured with a validity timer (measIdleValidityDuration) as part of the measIdleConfig, and the WTRU may report those measurement results that are not older than the configured validity duration. A validity duration may be configured for any appropriate time duration, such as, for example, between 5 and 100 seconds.

AIML may be utilized for NR. AIML may be utilized for network triggered Layer 3 (L3)-based handover (e.g., handover triggered by the network based on information received by the WTRU, such as measurement reports). Cell level measurement predictions of serving and neighbor cells may include Radio Resource Management (RRM) measurement prediction, such as, for example, predicting beam level results, then generate cell level results based on the predicted beam results; directly predicting cell level results based on cell level results; and directly predicting cell level results based on beam level results.

As described above, a WTRU may be configured to do measurements while it is in the IDLE/INACTIVE state for a certain duration and report the measurements upon transitioning to CONNECTED state, if the measurements are not older than the configured validity duration. For example, consider the case in which the WTRU was configured to do the measurements in IDLE/INACTIVE for 300 seconds and the validity duration was set to 10 seconds. That means, if the WTRU stays more than 310 seconds in IDLE/INACTIVE, the WTRU will not be reporting any measurements, and the measurements it has performed for 5 minutes would have been in vain. Since there is no definite way of knowing how long the WTRU will stay in the IDLE/INACTIVE state, there is no way to ensure the IDLE/INACTIVE measurements will be valid, except for configuring the WTRU to do the IDLE/INACTIVE measurements continuously, which is inefficient and overly power consuming.

Mechanisms described herein utilize measurement predictions to address measurements performed in IDLE/INACTIVE being outdated/invalid when the WTRU transitions to CONNECTED state. A WTRU may be configured to perform measurements and measurement predictions in IDLE/INACTIVE. The WTRU may perform the measurements for the configured idle measurement durations, and if it stays more than the idle measurement validity duration after it has stopped the measurements, it will perform measurement predictions. Upon transitioning to CONNECTED state, the WTRU may report the actual measurements (e.g., if they are still valid) or the predicted measurements, otherwise.

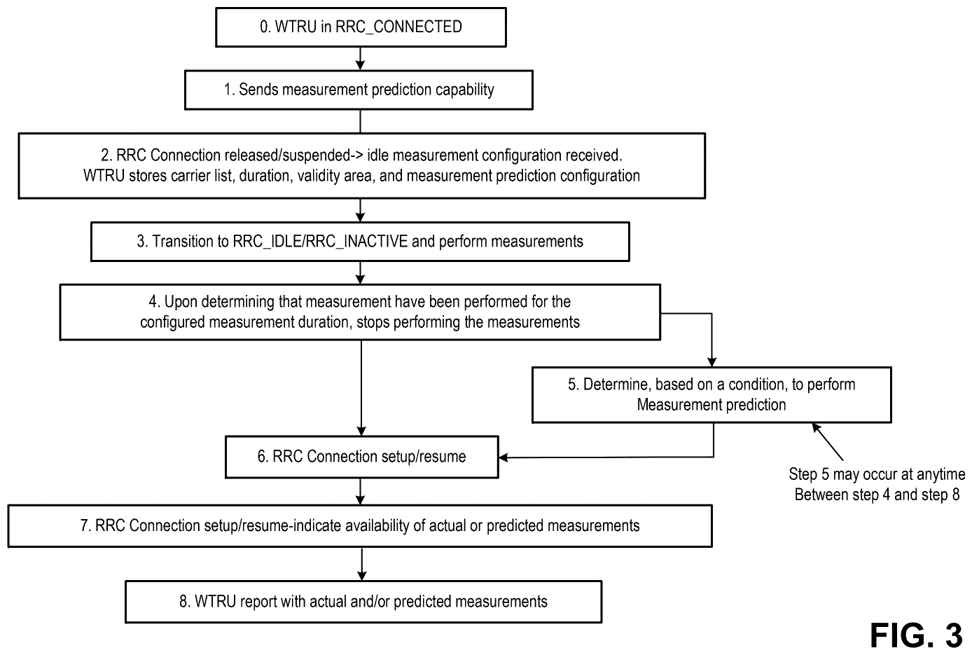

FIG. 3 depicts an example flow chart for performing measurements and measurement prediction. As shown in FIG. 3, a WTRU may be in the RRC_CONNECTD state at step 0. At step 1, the WTRU may send its measurement prediction capability. The WTRU may send an indication of its RRM measurement prediction capability (e.g., frequencies/cells that can be predicted, time of day and/or locations where predictions can be made, prediction window(s), confidence levels, etc.). The WTRU may send the indication to any appropriate entity, or entities, such as for example, a network node, which may include, but not limited to, a gNB, a base station, an Access and Mobility Function (AMF), a User Plane Function (UPF), a Unified Data Management (UDM), an Authentication Server Function (AUSF), an Application Server (AS), a Data Network (DN), a Session Management Function (SMF), a Network Slice Selection Function (NSSF, a Policy Control Function (PCF), an Application Function (AF), or the like.

At step 2, the WTRU may receive instructions for the WTRU to enter an idle/inactive state. The WTRU may receive a message from the network instructing it to transition to a lower power operating mode, such as an idle/inactive state (e.g., RRCRelease message transitioning the WTRU to IDLE/INACTIVE state). The message may contain configuration information associated with measurements to be performed while the WTRU is in the idle/inactive state (e.g., low power operating mode). The message may contain configuration information associated with measurements to be predicted while the WTRU is in the idle/inactive state (e.g., low power operating mode). The configuration information may comprise any appropriate information, such as, for example, measurements to be performed while the WTRU is in the inactive/idle state, measurements to be predicted while the WTRU is in the inactive/idle state, carriers/frequencies to be measured, measurement duration, measurement validity duration, validity area (e.g., list of cells where the measurement is to be performed), measurement prediction configuration, or the like, or any appropriate combination thereof.

At step 3, the WTRU may enter the inactive/idle state. The WTRU may transition to the idle/inactive state (e.g., low power operating mode-IDLE/INACTIVE) and may start performing the measurements according to (based on) the received configuration information. At step 4, upon determining that the measurements have been performed for the configured measurement duration, the WTRU may stop performing the measurements.

At step 5, while still in the inactive/idle state, based upon a trigger condition, the WTRU may predict measurements based on the received configuration information and the performed measurements. Upon determining, based on a condition (e.g. that more than the configuration validity duration has elapsed after stopping performing the measurements, or the like), the WTRU may start performing measurement predictions according to the measurement prediction configuration information. As shown in FIG. 3, step 5 may be performed by the WTRU at any time between steps 4 and 8.

At step 6, the WTRU may start/resume an RRC connection to transition to a connected state, e.g., full power operating mode (e.g., send an RRC Setup Request message or RRC Resume Request). The WTRU may start, or be triggered to start, this process upon receiving a message from the network instructing the WTRU to transition to full power operating mode (e.g., CONNECTED state) (e.g., a paging message indicating the arrival of a DL data) or detecting arrival of UL data. At step 7, the WTRU may send at least one of an indication of the performance measurements or an indication of the predicted measurements. The WTRU may send an indication to the network of the availability of actual or predicted measurement results. At step 8, upon receiving a request from the network (e.g. indication in the RRC Setup or RRC Resume message), the WTRU may send the actual or predicted measurement results.

A WTRU may indicate that it has one or more valid idle mode measurements available during or after RRC connection establishment. For example, the WTRU may provide this indication in RRC Setup Request (Msg3) or RRC Setup Complete (Msg5) or any other uplink message. The WTRU additionally or alternatively may indicate that it has one or more predicted idle mode measurements available during or after RRC Connection establishment. The WTRU may indicate that both predicted and real measurements are available (for example, predicted and real measurements may be available for the same cells, or for different cells).

The WTRU may indicate availability of (e.g. real) measurements with an indication that predictions may additionally be requested by the network. The indication may include an indication that some or no actual valid measurements are available, but predictions can be requested. The inclusion of an indication of availability may depend on whether measurements taken or predicted are still valid (e.g. within the configured validity duration). The WTRU may indicate that measurements were taken but are no longer valid.

A WTRU may receive an idle mode measurement configuration in an RRC (e.g. RRC Release message). The configuration may include one or more of the following. The idle mode measurement configuration may include an indication of a measurement duration, e.g. the length of time the WTRU may perform real measurements. The idle mode measurement configuration may include an indication of a prediction duration, e.g. the length of time the WTRU may perform predicted measurements. The idle mode measurement configuration may include an indication of a measurement pattern, e.g. the WTRU may be configured to perform some real measurements for a certain time, then perform predictions for a certain time. This may be periodic or performed only once. The idle mode measurement configuration may include an indication of a carrier or cell list, e.g., the cells or carriers to perform real or predicted measurements. A single carrier or cell list may be configured (e.g. to use for both real and predicted measurements) or separate lists may be configured for real and predicted measurements. The idle mode measurement configuration may include an indication of a validity area list, e.g., the cells or carriers in which (e.g. while camped) the WTRU may perform real or predicted measurements. A single validity area may be configured (e.g. to use for both real and predicted measurements) or separate lists may be configured for real and predicted measurements. The idle mode measurement configuration may include an indication of a reselection carrier list, e.g., the list of carriers which the WTRU is configured to record and report cell reselection measurements on. The idle mode measurement configuration may include an indication of a reselection measurement validity duration, e.g., a validity time used to determine whether the real or predicted idle mode measurements should be reported. The idle mode measurement configuration may include an indication of an idle measurement validity duration, e.g., a validity time used to determine whether the real or predicted cell reselection measurements should be reported. The idle mode measurement configuration may include an indication of a prediction model, e.g., a configuration of one or more models to use in the predicted measurements. The idle mode measurement configuration may include an indication of conditions for performing predictions, as described below, for example.

A WTRU may additionally or alternatively receive configurations in system information. A WTRU configured using RRC Release may perform a cell reselection to a new cell and receive further parameters from the new cell, such as, for example, whether idle measurements and/or predictions are enabled in that cell, update criteria or conditions for performing the measurements and/or predictions, updated validity time(s), updated reporting configuration(s), updated measurement duration(s), updated validity area(s), or any appropriate combination thereof.

A WTRU may be configured with one or more timers related to how and when to perform actual measurements or predicted measurements. For example, upon determining that the idle mode or cell reselection measurement duration has expired, the WTRU may be configured to start measurement prediction. A separate timer may be used, e.g., the WTRU may be configured to perform real measurements, and start predicted measurements after the expiry of a measurement prediction start time, which may occur before or after the real measurement duration time expires.

A WTRU may be configured to periodically perform real measurements (e.g., for a given duration, a given number of times, or at a given periodicity) and periodically perform predicted measurements (e.g., for a given duration, a given timber of times, or at a given periodicity). The duration or periodicity of real or predicted measurements may change over time, for example start relatively frequently, then reduce how often these real or predicted measurements are to occur.

A WTRU may be configured to perform real measurements for a given duration, then perform measurement predictions for a given duration. After expiry of both of these durations, the WTRU may stop performing measurement and prediction. Alternatively, after expiry of both of these durations the WTRU may restart real measurements (e.g., in order that predictions can again be reliably performed).

A WTRU may perform actual measurements for the configured duration, but not start predicted measurements. If the WTRU moves to a RRC_CONNECTED state within a given time after the measurement validity time has expired, but before a prediction time has expired, the WTRU may indicate that it is capable of providing a measurement prediction even though the actual measurement validity has expired. The network may then request explicitly that the WTRU performs a measurement prediction. For example, the WTRU may indicate in Msg3 or Msg5 (e.g., or any other uplink message) that predictions are possible based on expired real measurements. The network may then send a UE INFORMATION REQUEST message (or any other downlink message) to the WTRU to request a prediction, and the WTRU may then perform a prediction and respond in the UE INFORMATION RESPONSE message (or any other uplink message).

A WTRU may be configured with a measurement prediction validity time. If the predicted measurement is valid (e.g., the time of performing prediction or the predicted measurement time is within a certain time) upon a network request then the WTRU may include the predicted measurement in a report, and if the predicted measurement is no longer valid (e.g., the timer has expired) then the WTRU may omit the predicted measurement from a report.

A WTRU may be configured to perform real and predicted measurements in parallel, which may be configured to be performed for the same or for different durations. This may allow, for example, performance of less frequent measurements or predictions but for a longer duration.

A WTRU may be configured to perform real measurements on some cells or carriers, and predicted measurements on others. The WTRU may predict filtered measurements, or may predict measurement samples to derive a predicted measurement. A WTRU may use a combination of real and predicted measurements to derive a filtered value, or use a combination of predicted and real beam measurements to perform a cell quality derivation calculation.

A WTRU may be configured with conditions related to actual measurements that it monitors to determine whether it can start predictions for other measurements.

A WTRU may be configured with time or location based conditions, for example in the case of using Non-Terrestrial Network (NTN). For example, a WTRU may be triggered to perform real and/or predicted measurements when the WTRU location is within a threshold distance from a reference location. A WTRU may be triggered to perform real and/or predicted measurements when the absolute time measured at the WTRU is within a time window (e.g., between T1 and T2).

A WTRU may be configured with thresholds (e.g., RSRP, RSRQ, RSSI, SINR, CQI, CSI thresholds) of the serving cell or/and neighbor cells that it is actually measuring, and if these thresholds are fulfilled, the WTRU may be configured to start doing some measurement predictions. For example, if the serving cell signal level goes below threshold1, the WTRU may start doing temporal measurement prediction of the same cell, or/and start doing (spatial) measurement prediction of neighbor cells (e.g., all neighbor cells that the WTRU is not currently measuring or predicting, specific neighbor cells, neighbor cells at a certain frequency layer, etc.), and/or start doing (temporal) measurement prediction of neighbor cells (e.g., all neighbor cells that the WTRU is currently measuring, specific neighbor cells, neighbor cells at a certain frequency layer, etc.). If the measured neighbor cell signal level goes above threshold2, the WTRU may start doing temporal measurement prediction of that neighbor cell, and/or start doing temporal measurement prediction of the serving cell, and/or start doing temporal/spatial prediction of other neighbor cells (e.g. all neighbor cells the WTRU is currently measuring, all neighbor cells that the WTRU can predict/detect, specific neighbor cells, neighbor cells at a certain frequency layer, etc.). If the serving cell signal level becomes lower than the measured neighbor cell signal level by more than threshold3, the WTRU may start doing temporal measurement prediction of the serving cell and/or the concerned neighbor cell, start doing temporal measurement prediction of other neighbor cells that the WTRU currently measuring, start doing prediction of other neighbor cells that the WTRU is not currently measuring, etc.

A WTRU may be configured with thresholds (e.g., RSRP, RSRQ, RSSI, SINR, CQI, CSI thresholds) of the predicted measurements of serving cell or/and neighbor cells, and if these thresholds are fulfilled, the WTRU may be configured to start performing actual measurements. For example, if the predicted serving cell signal level (e.g., at a certain prediction window in the future) goes below threshold1, the WTRU may start performing the measurements of neighbor cells (e.g., all neighbor cells that the WTRU is not currently measuring or predicting, specific neighbor cells, neighbor cells at a certain frequency layer, etc.), and/or start performing (temporal) measurement prediction of neighbor cells (e.g., all neighbor cells that the WTRU is currently measuring, specific neighbor cells, neighbor cells at a certain frequency layer, etc.). If the predicted neighbor cell signal level goes above threshold2, the WTRU may start performing measurements of that neighbor cell, and/or start performing temporal measurement prediction of the serving cell, and/or start performing temporal/spatial prediction of other neighbor cells (e.g. all neighbor cells the WTRU is currently measuring, all neighbor cells that the WTRU can predict/detect, specific neighbor cells, neighbor cells at a certain frequency layer, etc.).

If the predicted serving cell signal level becomes lower than the predicted neighbor cell signal level by more than threshold3, the WTRU may start performing measurements of that neighbor cell or other neighbor cells, start doing temporal measurement prediction of other neighbor cells that the WTRU is currently measuring, start doing prediction of other neighbor cells that the WTRU is not currently measuring, etc.

A combination of the above is possible where a measurement to be performed (e.g., at a given cell, frequency, etc.) can be a function of some measurements and some predictions. The reverse is also possible, where predictions may be triggered based on some actual measurements and some predictions.

The above description are examples and by no means complete (e.g., not limiting). In general, the inter-dependency between the actual measurements and predictions can be generalized as: measurement to be performed (e.g., for a certain frequency layer f1, for a certain cell c1, etc.) =Function (e.g., predicted measurements for frequency layer f2, predicted measurements of cell c2, etc.); and measurement to be predicted (e.g., for a certain frequency layer f1, for a certain cell c1, etc.)=Function (e.g., measurements performed at frequency layer f2,predicted measurements of cell c2, etc.). As described above: f1 may be the same or different from f2; similarly, c1 can be the same or different from c2; f1, f2, c1, c2, etc. may refer to single values or a set/range of multiple values (e.g., f1=[fa, fb, fc], f2=[fd, fe], c1=[cellx, cell y], c2=[cell z], etc. ; f1, f2 may refer to serving or neighbor frequencies; and c1, c2 may refer to serving or neighbor cells.

The network may configure the WTRU in RRC_IDLE or in RRC_INACTIVE to derive RSRP and RSRQ measurement results per cell associated to NR carriers based on parameters configured in e.g., measIdleCarrierListNR within VarMeasIdleConfig and received in e.g., RRC Release and/or system information.

A new information element (IE) may be defined for configuring measurements for predictions (e.g., or additional IEs may be added to the current idle measurement configuration IE to include the new parameters related to predictions). This measurement configuration may contain all or a subset of the current configuration for performing actual measurements, and any additional IEs that are required for performing measurement predictions. For example, a measurement configuration may comprise an indication whether the WTRU uses direct or/and indirect predictions for this measurement. A measurement configuration may comprise an indication of parameters related to cell level measurement derivation and filtering (e.g., to be used for converting beam level measurements to cell level measurement for indirect predictions or to choose the proper model for the case of direct predictions, as discussed above). A measurement configuration may comprise an indication of beam consolidation thresholds for predicted beams and/or measured beams. A measurement configuration may comprise an indication of a number of predicted/measured beams that can be consolidated in the cell level measurement derivation. A measurement configuration may comprise an indication of filtering parameters while averaging samples that contain some actual measurements and some predictions (e.g., the weighting ratio between predicted samples and measured samples, etc.). A measurement configuration may comprise, in the case of spatial beam predictions, an indication of the beams that are to be measured and the beams that can be predicted. A measurement configuration may comprise, in the case of temporal predictions, an indication of the duration for the observation and prediction windows (e.g., measure for x ms, then predict for the next y ms, and so on).

The measurement (e.g., configuration) for actual measurements and predicted measurements may be the same (e.g., for a given frequency), but separate measurement configurations can be provided for predictions related to different cells at that frequency level (e.g., the common IEs that are applicable to both predictions and actual measurements may be provided in the legacy measurement configuration that is applicable to all measurements at that frequency layer, configuration 1 can contain prediction related configurations for cell 1,configuration 2 can contain prediction related configurations for cell 2, and so on). For a given cell, there may be actual measurement and prediction configurations (e.g., the WTRU is measuring the current cell but predictions measurements refer to temporal predictions. For a given cell, there could be only prediction related configurations (e.g., the WTRU will not be measuring the cell at all, but predicting the signal levels of that cell now, e.g., spatial prediction, and/or also temporally, e.g., future durations).

The above configuration for the prediction may be implicit. For example, the WTRU may have communicated to the network the detailed capabilities of the AIML models that it has, and the network may just indicate which AIML model the WTRU needs to use for a given measurement. The configuration may be explicit, and the WTRU will determine the appropriate model for that configuration. In the latter (e.g., explicit) case, if the WTRU determines that it has no AIML model that will be able to do the predictions according to the received prediction configuration, it may respond to the network indicating that it is not able to do the predictions (e.g., in an RRC reconfiguration complete message as a respond to the measurement prediction configuration, including a cause value for the failure to do the predictions). The WTRU may consider this as an error (e.g., Radio link failure) and may trigger a recovery procedure such as an RRC re-establishment (e.g., with a cause value indicating invalid prediction configuration).

The WTRU may not have communicated all the details of the AIML models/functionalities it has to the network, and once the network has configured it for measurement prediction (e.g., by explicitly configuring some of the parameters above), the WTRU may respond to the network with information about the details of the predictions that it is going to perform (e.g., the prediction KPIs such as accuracy levels, observation/prediction window, number of cells that can be predicted, particular cells that can be predicted, additional configurations the WTRU may need to do the predictions, etc.).

A WTRU may receive a separate measurement and reporting configuration for actual measurements and predictions. An example configuration may comprise: measurement object configuration 1—for actual measurements related to frequency x (e.g., or a specific cell or group of cells in that frequency layer); measurement object configuration 2—for measurement prediction related to frequency x (e.g., or a specific cell or group of cells in that frequency layer); reporting configuration 1; reporting configuration 2; measurement ID1-: associating measurement object 1 and reporting configuration 1; and measurement ID2—associating measurement object 2 and reporting configuration 2.

The reporting configuration for predicted measurements may contain all the information that is currently configurable for actual measurements (e.g., periodicity, thresholds, etc.). The reporting configuration for predicted measurements may contain additional parameters/IEs. For example, the reporting configuration for predicted measurements may contain information regarding the number of predicted samples to include in one prediction report. Also, this may be specified in terms of time duration. The reporting configuration for predicted measurements may indicate to the WTRU if individual predicted samples or/and statistical information of these samples is to be included in the report. For example, the WTRU may be configured to include one or more of the following in the predicted measurement report. The WTRU may be configured to include in the predicted measurement report a certain number of predicted samples in the future. The WTRU may be configured to include in the predicted measurement report all the predicted samples within a given future time duration/window. The WTRU may be configured to include in the predicted measurement report the top n strongest predicted samples in the reporting/prediction time duration (e.g., the prediction window for the model being used). The WTRU may be configured to include in the predicted measurement report the bottom n predicted samples in the reporting/prediction time duration (e.g., the prediction window for the model being used). The WTRU may be configured to include in the predicted measurement report the mean or/and median of the samples in the reporting/prediction time duration. The WTRU may be configured to include in the predicted measurement report the range (e.g., maximum and minimum) of the samples. The WTRU may be configured to include in the predicted measurement report other statistical information (e.g., standard deviation, number/percentage of samples above/below a certain threshold, etc.).

The WTRU may receive a common measurement object configuration for actual measurements and predictions but separate reporting configurations for the two, for example: measurement object configuration 1—for actual and predicted measurements related to frequency x (e.g., or a specific cell or group of cells in that frequency layer); reporting configuration 1; reporting configuration 2; measurement ID1—associating measurement object 1 and reporting configuration 1, and measurement ID2—associating measurement object 1 and reporting configuration 2. The reporting configuration may include all the information discussed above for the separate measurement object/reporting configuration, but additionally may include the configuration related to performing the measurements as well.

The WTRU may be provided with one common reporting configuration that includes configuration/parameters related to the reporting of actual measurements and parameters related to the reporting of predicted measurements (e.g., for all cells at a given frequency layer, for specific cell or group of cells, etc.).

The number of predicted samples to be included or the time duration window may be implicit (e.g., based on the indicated AIML capability of the RRM measurement prediction model) or it may be explicit. For example, the WTRU may have indicated it can predict for time duration window of length T1, and network may configure the WTRU to report the predictions for only time duration of length T2, where T2<T1. In another example, the WTRU may have indicated that it can support T1 and T2 prediction time durations (e.g., with different accuracy levels), and the reporting configuration may indicate which time duration to be chose by the WTRU during reporting. Similar configurations can be done for the reporting configuration that indicates number of samples instead of time durations.

Any appropriate information may be included in the measurement reports and relationship between actual measurement and predicted measurement results/reports. The WTRU may be configured to send a measurement report that contains a combination of actual and predicted measurements. For example, the WTRU may include the actual measurements now and a certain number of samples of predicted measurements in the future (e.g., according to any of the mechanisms discussed above). For example, in one measurement report, the WTRU may contain any appropriate combination of the following information. For cell a, the measurement report may comprise only one measurement result indicating current signal level of cell a. For cell b,, the measurement report may comprise only one predicted measurement result indicating the predicted signal level of cell b right now (e.g., if cell b is not measured at all and only predicted). For cell c,, the measurement report may comprise multiple results, the first one indicating measured signal level of cell c right now, and the rest indicating predicted future values. For cell d, the measurement report may comprise multiple results, the first one indicating the predicted signal level of cell d right now, and the rest indicating predicted future values.

Instead of multiple future values, as discussed above, a summarized/statistical information may be provided regarding predicted measurements (e.g., such as average values, ranges, standard deviations, etc.).

Whether the WTRU includes the individual predicted samples or the summarized/statical values may be configured to be dependent on the predictions (e.g., include samples if there are more than a certain number/percentage of samples above/below a certain signal level threshold, include samples if the range of the predicted values is within/outside a certain range, include the samples if the standard deviation of the samples is above a certain value, etc.).

The WTRU may be configured to include an indication regarding the number of predicted samples that are included or whether summarized/statistical information is included (e.g., if the WTRU was configured to vary the number of samples included according to any of the mechanism describe above, for example, include the average and standard deviation rather than multiple sample values).

The number of predicted samples to be included or the statistical/summarized information to be included may be the same at a measurement report level (e.g., all the reported cells will comprise the same number of predicted samples). There may be several alternatives to decide the number of samples or whether or not to use statistical information. For example, if n cells were to be included in the measurement report, and for the majority of the cells, the predictions results were in such a way that individual samples were not required (e.g. most of the cells were showing stable radio conditions in the prediction window), the WTRU may be configured to include only statistical/summarized information for all the reported cells (e.g., even if there was one cell that was not showing stable conditions, only summarized/statistical information about this cell's predicted signal levels will be included in the report). On the other hand, if the majority of the cells were predicted to have unstable (e.g., or highly varying signal levels) within the prediction window that is being reported, individual predicted samples may be included in the report (e.g. even for the cells that were having stable conditions during the prediction window). Instead of or in addition to stability/variability conditions, the WTRU may be configured with actual signal level thresholds to make the decisions (e.g., include samples if there are a majority of neighbor cells that are predicted to have a signal level above x or have a signal level better than source cell by more than y, etc.).

As another example, the WTRU may decide to include individual samples or statistical/summarized information (e.g., and the number of samples to be included in the former case) based on the predicted results of the serving cell. For example, if the predicted results for the serving cell, mandates the sending of individual samples, the WTRU may include individual predicted samples for the neighbor cells as well, regardless of the prediction results of the neighbor cells. Alternatively, the WTRU may include summarized version of the neighbor cell results if it is including individual samples for the serving cell, or vice versa.

As yet another example, which is similar to the previous example, the decision may be based upon one or more of the neighbor cells predicted signal levels within the prediction window, rather than the serving cell.

The number of predicted samples or the statistical/summarized information to be included in the measurement report may be different for the different cells included in the same measurement report. For example, the WTRU may include x number of samples for cell 1, y number of samples for cell 2, and only statical information for cell 3, and so on (where the determination is made separately for each cell, according to the received configuration for performing these decisions, according to any of the mechanisms discussed above).

The WTRU may be configured with a relationship between the predicted measurement reports.

The WTRU may be configured to trigger a report of certain actual measurement results based on prediction results (e.g., if the prediction of the serving cell is indicating a signal level lower than a certain level within a certain prediction time window, the WTRU may trigger a report that contains actual measurement results of the serving cell and the neighbor cells the WTRU is measuring).

The WTRU may be configured to trigger a report of certain predicted measurement results based on actual measurements (e.g., if the serving cell's signal level is measured to be below a certain level indicating a signal level lower than a certain level within a certain prediction time window, the WTRU may trigger a report that contains actual measurement results of the serving cell and the neighbor cells the WTRU is measuring).

The WTRU may be configured to skip the sending of actual measurement results if it has previously sent a predicted measurement report that is found to be correct. For example, assume the WTRU sent a predicted measurement result at time t1, indicating the predicted measurement results at t1+delta, t1+2*delta, . . . t1+n*delta. Assume the WTRU also is configured to send actual measurements at periodicity of m*delta (e.g., m=2). At the next reporting interval, the WTRU may check the current measurements and find out that the previously predicated measurements at t1+delta and t2+delta were correct (e.g., the difference between actual and predicted values is lower than a certain configured threshold), and may refrain from sending the measurement report. Instead of comparing each individual value, the comparison could be based on comparing averages or some other statical metric. For the previous example, the WTRU may average the 2 measured samples and also average the two previously reported predicted samples and compare the difference between the two average values to determine whether a measurement report should be sent or not.

The WTRU's decision may be to send a measurement report but to include or not include the measurement results of a particular cell in the measurement report. For example, if the WTRU has previously sent a predicted measurement result of n cells, the determination to include the actual measurements of the individual cells may be performed separately (e.g., according to the mechanisms described above, for example) and the final report may be generated, which includes results of only the cells where it has been determined to include the measurements. The WTRU may include some indication regarding the cells that were not included in the measurement report (e.g., a list of these cells, or just one value that indicates previous predicted values are still valid corresponding to each cell's measurement entry, etc.).

The decision to send or not send a measurement report may be based on considering how the predicted measurements for the multiple cells compare to the current measurements of these cells. For example, if the WTRU included predictions for cell's 1 to n in the earlier measurement report, the WTRU may check how many of these measurements are now determined to be correct (according to any of the cells above), and if the majority of the predictions were correct, the WTRU may not send the measurement report (e.g., or it may send a simple indication, just indicating previous prediction reports were valid).

Instead of the decision being based on the majority, the decision may be based on the measurements of the serving cell. For example, if the serving cell's predictions were accurate, the WTRU may refrain from sending the measurement report (e.g., or just indicates previous prediction reports were valid), even if there were one or more neighbor cells regarding which the predictions were not correct. Similarly, if the serving cell's predictions were determined to be not accurate, the WTRU may trigger the measurement and include measurement results of one or more neighbor cells, even if the predictions of these neighbor cells were determined to have been accurate. The validity/correctness of one or more neighbor cells may be used in the determination of whether a measurement report for actual measurement results should be sent or not, instead of the validity/correctness of the serving cell's measurement predictions.

The WTRU may be configured to send predicted measurement results for the next prediction window depending on the accuracy of the predictions in one or more previous prediction windows. For example, if the prediction of the previous window was determined to be valid/correct within the one or more previous window, the WTRU may trigger the sending of the prediction for the next prediction window. The WTRU may be configured by the number of previous windows to consider determining the accuracy. Several examples of such configuration are provided. For example, the WTRU may be configured to send the next prediction window results only if more than a certain number or percentage of the predictions in the previous n prediction windows were determined to be valid/correct. The WTRU may be configured to send the next prediction window results only if there were a certain number of consecutive predictions windows where the prediction was determined to be valid/correct. The WTRU may be configured to send the next prediction window results only if there were not more than a certain number of consecutive predictions windows where the prediction was determined to be invalid/incorrect.

Decisions could be done per individual cell level or at measurement report level, similar to the mechanisms discussed above.

The WTRU, if it is has decided not to send predicted measurement report (regarding a certain cell or the whole measurement altogether according to any of the mechanisms above), may send an indication to the network regarding same (e.g., an empty report, a preconfigured indication value, a measurement report that includes separate indication for the individual concerned cells, etc.).

The WTRU may report early measurements and indicate the prediction parameters used (e.g. number of predicted samples, number of measured samples, confidence, etc.). Depending on the availability indications, the WTRU may be configured to report only the predicted measurements, only the real measurements, or both.

A WTRU may indicate early predicted measurement reporting capability. For example, the WTRU may indicate that it is capable of performing measurement prediction in RRC_IDLE and/or RRC_INACTIVE for reporting during or after RRC establishment or resume.

The WTRU may indicate that it is capable of beam level predictions and can perform the cell level measurement predictions based on these beam level predictions. This is referred as indirect predictions henceforth.

The WTRU's capability indication regarding beam level measurements may include one or more of the following. The WTRU's capability indication regarding beam level measurements may comprise beam prediction type. Beam prediction type may comprise a temporal prediction-(e.g., prediction of the signal level of a beam at a future time instance based on, e.g., current and historical signal levels of the beam). Beam prediction type may comprise a spatial prediction (e.g., prediction of the signal level of one beam based on the signal level of another beam, e.g., beam of the same cell, beam of a different cell, etc.). Beam prediction type may comprise a number of beams that can be predicted. Beam prediction type may comprise a number of beams that need to be measured to do the predictions. Beam prediction type may comprise a confidence level of the predictions. Beam prediction type may comprise frequencies that can be predicted. Beam prediction type may comprise cells that can be predicted. Beam prediction type may comprise conditions under which the AIML functionality/models can operate at (e.g., the models/functionality were trained under the indicated conditions, where the performance of the models/functionality has been tested and shown to work properly, etc.), where the conditions could contain WTRU and/or Network conditions (e.g., WTRU mobility state, WTRU location, cells/frequencies, time of day, network configuration index such as associated ID, etc.).

The WTRU may indicate that it can predict cell level measurements directly (e.g., the output of the AIML model is a cell level measurement). This is referred as direct predictions henceforth.

The capability information for direct predictions may contain similar information like the beam level predictions (e.g., temporal vs spatial, number of cells that can be predicted, the cells/frequencies that can be predicted, confidence level of predictions, input/configuration required to do the predictions, WTRU/network conditions for predictions, etc.).

A WTRU may be capable of performing both direct and indirect predictions (e.g., direct prediction for certain cells/frequencies, indirect predictions for other cells/frequencies, direct predictions for certain locations, indirect predictions for other locations, etc.).

The WTRU may indicate to the network its capability related to time domain prediction such as observation window and prediction window sizes (e.g., WTRU informing that the model is trained to use measurements observed within the prediction window duration, and maybe earlier measurements before that, to predict measurements for the next prediction window duration). The WTRU may provide multiple observation window and prediction window combinations, each associated with different KPI thresholds (e.g., different accuracy levels, different RSRP difference levels between predictions and measurements, etc.). The observation/prediction window capability may be the same for all measurements (e.g., all cells, frequencies, etc.). The WTRU may have different observation/prediction window capability for different measurements (e.g., cells, frequencies, etc.). The WTRU may support the same observation/prediction window sizes for all measurements, but it may have different KPI thresholds for the different measurements (e.g., observation window size of x and prediction window size of y supported for predicting a cell at frequency fa and frequency fb, but the prediction accuracy for fa during that prediction window is level 1 while for that of fb is level 2).

The observation and prediction window sizes may be specified in time durations (e.g., observation window=x ms, prediction window=y ms). The observation and prediction window sizes may be specified in number of measurement samples (e.g., observation window=10 samples, prediction window=5 samples).

The KPIs within the prediction window may vary from sample to sample within the prediction window. For example, assume the prediction window is equal to 10 samples, then the prediction accuracy for the first 2 samples can be of level 1, for the next 3 samples could be of level 2, and so on. The same differentiation may be applied for sub time duration within the prediction window, if the prediction window is specified in time durations instead of number of measurement samples.

The capability may be provided at a functionality level (e.g., WTRU not explicitly indicating the number/identity of the models it is using, but simply providing the overall capability of the one or more models for the beam prediction capability) or it can be model level (e.g., WTRU providing explicit information about each model it has for the beam prediction functionality and associated capability information for each model).

The capability information may be provided autonomously by the WTRU (e.g., upon connection setup/resume, upon handover, upon detecting that the WTRU has entered a new cell/region/RAT where the capability regarding beam prediction is different from previously reported capability, etc.) or based on an explicit request from the network.

If capability information is requested from the network, the request may be a generic request (e.g., in which case the WTRU may provide all its capabilities) or it can be a more granular request. For example, the WTRU may receive a request from the network if it supports beam prediction at a certain frequency layer, and the WTRU may respond with an indication that it does not support beam prediction at a certain frequency layer, or an indication that it supports beam prediction at a certain frequency layer or/and detailed information about the capability regarding prediction of beam at the frequency layer (e.g., summarized information at functionality level, detailed information for each AIML model that supported beam prediction at that frequency layer, etc.).

Regarding aspects related to indirect prediction, a WTRU may be configured on how to derive cell level measurements from predicted beams or a combination of predicted and actual beams. For example, assume the WTRU is measuring n1 beams of a cell and predicting n2 beams of the cell. To derive the cell level measurements, the WTRU may be configured with one or more of the following parameters that tells it on how to do this determination. The WTRU may be configured with a beam consolidation threshold (e.g., RSRP threshold) for a beam to be considered for cell level measurement derivation. This threshold can be the same for actual measured beams and predicted beams, or it could be different (e.g., if different, the values can be independent or dependent on each other, e.g., the threshold for predicted beams being configured to be a scaled up/down value of the threshold for the actual beams). The WTRU may be configured with a number of beams to be considered/averaged in the cell measurement derivation. In one example, this could be a total number, regardless of the beams being predicted or measured (e.g., WTRU configured with n=n_total, and consider n_total beams with the highest RSRP in the beam consolidation, where the beams can be actual measured or predicted, if they have RSRP above the corresponding beam consolidation threshold). The WTRU may be configured to consider a certain number of predicted beams (n_total_predicted) and a certain number of measured beams (n_total_measured) in the cell level measurement derivation, if they fulfill the corresponding beam consolidation threshold. Once the average for the predicted ones is calculated out of the predicted ones and measured one, the two values can be combined equally (i.e., average of the two) or a weighted averaging is performed (e.g., measured beams have double the weight of the predicted one, i.e., cell level measurement=(e.g., 2*average of measured beams+average of predicted beams)/3). If the WTRU is doing temporal prediction of a certain cell (e.g., measure the beams of a given cell during T1 observation window, then predict them during T2 observation window, and so on), the WTRU may be configured with different filtering weights specified for considering values that are predicted and measured. For example, more weight could be given to measured values than predicted values (or vice versa).

In all the above, the different parameters may be dependent upon the accuracy/confidence level of the predictions (e.g., more predicted beams considered in the beam consolidation for higher confidence level predictions, larger filtering weight values given to predicted beams when the confidence level is higher, etc.). The WTRU may be configured with scaling factors or a mapping of different prediction accuracy/confidence levels and the different filtering/averaging weights and number of predicted beams to be considered.

To derive cell level measurement, a legacy WTRU has to be configured with several parameters such as beam consolidation thresholds, number of beams to consolidate, filtering parameters, etc.

Regarding aspects related to direct prediction, when a WTRU communicates capability for direct cell level measurement prediction, it may indicate to the network the value of one or more of the parameters that were used in the training of the model. That is, during model training, the model output must be compared with the actual value at that time (referred to as ground truth henceforth). And this ground truth is the actual cell level measurement derived from actual measured beams using the cell level derivation and filtering parameters.

The WTRU may indicate to the network that it has capability to do direct cell level measurement prediction for different cell level measurement derivation parameters. For example the WTRU may indicate that it can do direct cell level measurement prediction for parameter set 1, 2, . . . n, where each parameter set indicates a set of values (or range of values) for the different parameters such as beam consolidation thresholds, number of beams to be consolidated, filtering coefficients, etc.). The WTRU may indicate different characteristics for the models for the different parameter set (e.g., model trained for parameter set 1 may have different confidence level than model trained for parameter 2, etc.).

The WTRU may have different/separate models for the different parameter sets. For example, the WTRU may have one model that can take the parameter values as an input to the model.

The WTRU may receive a configuration from the network indicating the parameter set to be used for the direct cell level prediction. For example, if the WTRU has separate models trained for the different parameter sets, it will use the model that corresponds to the indicated parameter set. In another example, if the parameter set were input variables to one model, the WTRU will use those input values for that model when starting to perform the cell level measurement inference.

The WTRU may receive a configuration from the network indicating a parameter set and it may not have a model that perfectly matches the indicated parameters. In that case, the WTRU may be configured to use the model that is trained with the parameter set that is the closest from the indicated parameter set. For example, if the WTRU has two models, one trained for the maximum number of beams for beam consolidation equal to 3 and the other one trained for beams to be consolidated to be equal to 6, and the indicated parameter from the network was 5, the WTRU may choose to use the latter model.

The WTRU may have capability to perform both direct and indirect predictions for a certain frequency/cell. In that case, the decision to use one or the other can be based on explicit configuration from the network, or based on some WTRU decision (e.g., by looking at the required beam consolidation thresholds, number of beams to be consolidated, filtering parameters, etc., the WTRU may determine if it has a direct AIML model that can do that, and if so, uses it, otherwise, it may resort to doing indirect predictions by performing the beam level predictions and deriving the cell level measurement from that).

The WTRU may be able to ‘translate’ prediction results from a model trained for a certain cell measurement derivation parameters into another one, and communicates this information to the network, and network may configure it to do so (e.g., model was trained for cell measurement derivation parameter set 1, network configures WTRU to do the derivation using parameter set 2, WTRU will do the prediction using the model trained for parameter set 1 but will translate/transform the prediction results before sending the measurements to the network).

Regarding the relationship between predictions and measurements, a WTRU may provide information to the network regarding the cells and/or frequencies that it can predict. This information may include additional information (e.g., in addition to the detailed capability related information discussed above such as confidence levels, observation/prediction window sizes, etc.) such as the inputs required for the WTRU's AIML model to make the inference. For example, this could be a relationship between the cell/frequency to be predicted and cells/frequencies being measured. For example, the WTRU may inform the network that in order to predict measurements of cell x, it needs to have actual cell/beam level measurements of cell y and z. For example, the WTRU may provide a set of such lists, including the cells/frequencies to be predicted and the corresponding cells/frequencies to be measured and used as input to do these predictions.

The WTRU may provide additional information that is related to configurations to perform certain predictions. For example, if indirect predictions are to be made from beam level predictions, the WTRU may indicate the required Set A/B configurations required for that prediction.

The WTRU may indicate a high level information in the WTRU capability (e.g., cells, frequencies that can be predicted), and it may provide further information on the required measurements or configurations for doing the predictions on further request from the network. This request could be an implicit or explicit request.

The response from the WTRU regarding an explicit request may be an indication of support or non-support (e.g., 0 indicating not supporting and 1 indicating support, or a bitmap incase the request concerned multiple cells or/and frequencies, each bit corresponding to the indicated cell and/or frequency in the request) or it may include detailed information such as capabilities for the prediction such as accuracy levels/confidence levels, prediction/observation window sizes (e.g., for each cell and/or frequency indicated in the request).

The WTRU may provide all the detailed information of inter-dependency between required measurements/configurations and predictions in the WTRU capability information.

The WTRU may provide information regarding the inter-dependency between required measurements/configurations and predictions upon executing a handover (e.g., in the handover complete message, in a separate message, just an indication of such information availability in the handover complete message and providing the detailed information on further explicit request from the network, etc.). For example, the WTRU may inform the new serving cell that while in this cell, it can perform predictions of the following neighbor cells (x, y, z), etc. The WTRU may further indicate that the relationship between the signal level range of the current serving cell and the predictions (e.g., prediction of cell x and y is possible if the current serving cell signal level is between threshold1 and threshold2, prediction of cell z is possible if current serving cell signal level is between threshold3 and threshold4 and cell a is also being measured and having a signal level between threshold5 and threshold6, etc.).

The WTRU may provide information regarding the inter-dependency between required measurements/configurations and predictions upon executing an RRC connection setup or RRC connection resume. All the information may be included in the setup/resume complete message, or the WTRU may send an indication of information availability in the resume/setup complete message and detailed information upon further request from the network, or send the indication in the resume/setup request message and detailed information upon further request from the network, etc.).

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods, apparatuses, and articles of manufacture, within the scope of the disclosure, in addition to those enumerated herein, will be apparent to those skilled in the art from the foregoing descriptions. Such modifications and variations are intended to fall within the scope of the appended claims.

In addition, methods provided herein may be implemented in a computer program, software, or firmware incorporated in a computer-readable medium for execution by a computer or processor. Examples of computer-readable media include electronic signals (e.g., transmitted over wired or wireless connections) and computer-readable storage media (e.g., which do not include transitory signals). Examples of computer-readable storage media, which are differentiated from signals, may include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Any of the operations, processes, etc. described herein may be implemented as computer-readable instructions stored on a computer-readable storage medium. The computer-readable instructions may be executed by a processor of a mobile unit, a network element, and/or any other computing device.

What is claimed is:

1. A wireless transmit/receive unit (WTRU) comprising:
a transceiver: and
a processor configured to:
send, via the transceiver, an indication of a measurement prediction capability;
receive, via the transceiver, a message comprising:
instructions for the WTRU to enter an idle state or an inactive state;
configuration information associated with measurements to be performed while the WTRU is in the idle state or the inactive state; and
configuration information associated with measurements to be predicted while the WTRU is in the idle state or the inactive state;
enter the idle state or the inactive state;
while in the idle state or the inactive state, perform measurements based on the received configuration information;
while in the idle state or the inactive state, based on a trigger condition, predict measurements based on the received configuration information and the performed measurements;
transition to a connected state; and
send, via the transceiver, at least one of an indication of the performed measurements or an indication of the predicted measurements.

2. The WTRU of claim 1, wherein the measurement prediction capability comprises at least one of a frequency associated with the measurement prediction, a cell associated with the measure prediction, a time associated with the measurement prediction, a location associated with the measurement prediction, or a confidence level associated with the measurement prediction.

3. The WTRU of claim 1, wherein the measurement prediction capability is sent in a radio resource control (RRC) message.

4. The WTRU of claim 1, wherein the message comprises a radio resource control release (RRCRelease) message.

5. The WTRU of claim 1, wherein the configuration information comprises at least one of a carrier associated with measurement performance, a frequency associated with measurement performance, a measurement duration, a measurement validity duration, or a validity area.

6. The WTRU of claim 1, wherein the configuration information comprises at least one of a carrier associated with measurement prediction, a frequency associated with measurement prediction, a prediction duration, a prediction validity duration, or a prediction model.

7. The WTRU of claim 1, wherein the trigger condition comprises an expiration of a validity duration.

8. The WTRU of claim 1, wherein the trigger condition comprises a location of the WTRU being within a threshold distance from a reference location.

9. The WTRU of claim 1, wherein the trigger condition comprises an absolute time measured at the WTRU being within a time window.

10. The WTRU of claim 1, wherein the transition to the connected state is based upon at least one of receipt of a paging message comprising an indication of downlink (DL) data, detection of uplink (UL) data, receipt of a radio resource control (RRC) setup request message, or receipt of an RRC resume request message.

11. A method performed by a wireless transmit/receive unit (WTRU), the method comprising:
sending an indication of a measurement prediction capability;
receiving a message comprising:
instructions for the WTRU to enter an idle state or an inactive state;
configuration information associated with measurements to be performed while the WTRU is in the idle state or the inactive state; and
configuration information associated with measurements to be predicted while the WTRU is in the idle state or the inactive state;
entering the idle state or the inactive state;
while in the idle state or the inactive state, performing measurements based on the received configuration information;
while in the idle state or the inactive state, based on a trigger condition, predicting measurements based on the received configuration information and the performed measurements;
transitioning to a connected state; and
sending at least one of an indication of the performed measurements or an indication of the predicted measurements.

12. The method of claim 11, wherein the measurement prediction capability comprises at least one of a frequency associated with the measurement prediction, a cell associated with the measure prediction, a time associated with the measurement prediction, a location associated with the measurement prediction, or a confidence level associated with the measurement prediction.

13. The method of claim 11, wherein the measurement prediction capability is sent in a radio resource control (RRC) message.

14. The method of claim 11, wherein the message comprises a radio resource control release (RRCRelease) message.

15. The method of claim 11, wherein the configuration information comprises at least one of a carrier associated with measurement performance, a frequency associated with measurement performance, a measurement duration, a measurement validity duration, or a validity area.

16. The method of claim 11, wherein the configuration information comprises at least one of a carrier associated with measurement prediction, a frequency associated with measurement prediction, a prediction duration, a prediction validity duration, or a prediction model.

17. The method of claim 11, wherein the trigger condition comprises an expiration of a validity duration.

18. The method of claim 11, wherein the trigger condition comprises a location of the WTRU being within a threshold distance from a reference location.

19. The method of claim 11, wherein the trigger condition comprises an absolute time measured at the WTRU being within a time window.

20. The method of claim 11, wherein the transition to the connected state is based upon at least one of receipt of a paging message comprising an indication of downlink (DL) data, detection of uplink (UL) data, receipt of a radio resource control (RRC) setup request message, or receipt of an RRC resume request message.
